(19) United States
(12) Patent Application Publication
(10) Pub. No.: US 2010/0107884 A1
(43) Pub. Date: May 6, 2010

(54) AIR FILTER

(75) Inventor: PAUL LIN, Tainan Hsien (TW)

Correspondence Address: FULWIDER PATTON LLP, HOWARD HUGHES CENTER, 6060 CENTER DRIVE, TENTH FLOOR, LOS ANGELES, CA, 90045, US

(73) Assignee: MACAUTO INDUSTRIAL CO., LTD., Tainan Hsien (TW)

(21) Appl. No.: 12/262,997

(22) Filed: Oct. 31, 2008

(51) Int. Cl. B01D 39/20

(52) U.S. Cl. 96/222

(57) ABSTRACT

An air filter is adapted to be mounted on an air circulation path, and includes a filter body, an activated carbon layer provided on an outer surface of the filter body, and a fragrance material attached to the activated carbon layer. The activated carbon layer is a coating layer provided on the outer surface of the filter body through a spraying process followed by a drying process.

### BACKGROUND OF THE INVENTION

1. Field of the Invention

This invention relates to a filter, more particularly to an air filter that is adapted to be mounted on an air circulation path.

2. Description of the Related Art

Referring to FIG. 1, an activated carbon filter 1 for a car, as disclosed in Taiwanese Publication No. 207126, is installed in an air inlet 10 of the car, and includes a plastic frame 11, an activated carbon filter mesh 12 disposed in the frame 11, and a plurality of fixing elements 13 for fixing the frame 11 on the car. Each fixing element 13 may be a clamp or a screw. The filter mesh 12 has a sandwich mesh structure, and has activated carbon uniformly arranged within the filter mesh 12. An outer periphery of the filter mesh 12 is connected integrally to the frame 11.

The main purpose of installing the filter 1 in the air inlet 10 of the car to allow the filter mesh 12 to filter dirt in the air and to allow the activated carbon in the filter mesh 12 to remove unpleasant odors in the air. However, the filter 1 cannot provide a fragrant odor after filtering the dirt and bad odor in the air.

### SUMMARY OF THE INVENTION

Therefore, the object of the present invention is to provide an air filter that can provide a predetermined fragrance to enhance the quality of air after filtering.

According to this invention, an air filter is adapted to be mounted on an air circulation path, and comprises a filter body, an activated carbon layer provided on an outer surface of the filter body, and a fragrance material attached to the activated carbon layer.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a perspective view of an activated carbon filter disclosed in Taiwanese Publication No. 207126;

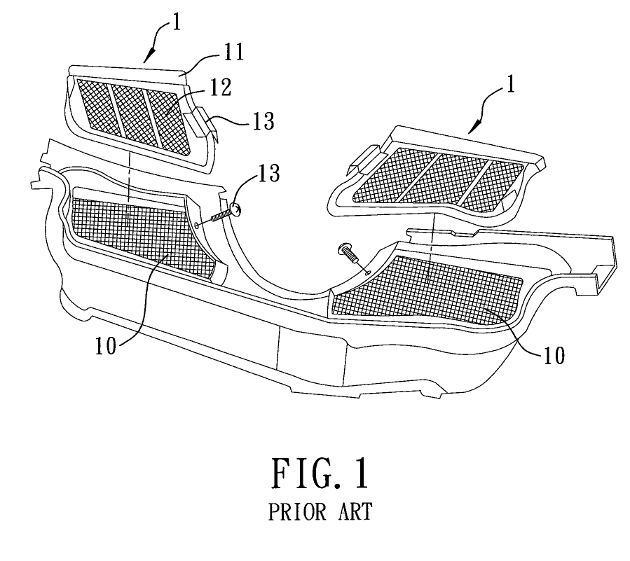

FIG. 2 is a fragmentary schematic side view of an air filter according to the first preferred embodiment of the present invention;

FIG. 3 is a schematic view, illustrating the steps involved in making the air filter of the present invention; and

FIG. 4 is an exploded schematic view of an air filter according to the second preferred embodiment of the present invention.

### DETAILED DESCRIPTION OF THE PREFERRED EMBODIMENTS

Before the present invention is described in greater detail, it should be noted that the same reference numerals have been used to denote like elements throughout the specification.

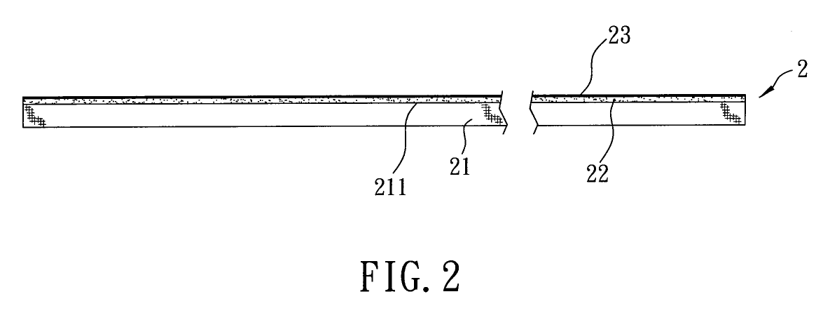

Referring to FIG. 2, an air filter 2 according to the first preferred embodiment of the present invention is adapted to be mounted on an air circulation path of a car, an air-conditioning unit, an air filter unit, etc., and is shown to comprise a filter body 21, an activated carbon layer 22, and a fragrance material 23.

The filter body 21 may be made of a non-woven fabric, a knitted fabric, a plain jersey fabric, or other fabric material having minute holes that are densely formed. In order to facilitate installation of the air filter 2, for example in an air outlet of an air-conditioning unit, the filter body 21 may be disposed first in a frame (not shown).

The activated carbon layer 22, in this embodiment, is a coating layer fixed on an outer surface 211 of the filter body 21 through a spraying process followed by a drying process.

The fragrance material 23, in this embodiment, is attached to the activated carbon layer 22 through a spraying process followed by a drying process. Hence, after production, the fragrance material 23 and the filter body 21 are disposed on two opposite sides of the activated carbon layer 22, respectively.

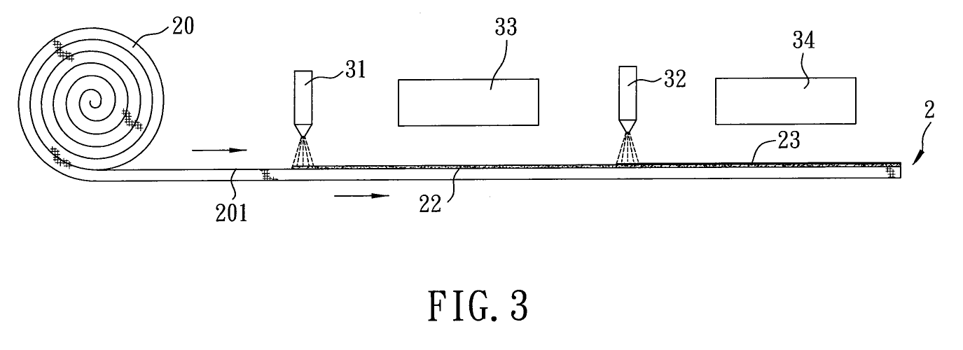

To make the air filter 2, a roll of screen 20 (see FIG. 3) made from a non-woven fabric, an activated carbon-containing spray liquid, and a fragrant spray liquid are prepared. The activated carbon spray liquid may, for example, include a solution having activated carbon powder contained therein. The fragrant spray liquid may, for example, be an alcohol mixed with fragrance. In this embodiment, the concentration and type of the fragrance have no special limitation. Generally, the fragrance may come from an essential oil extracted from the root, stem, leaf, or flower of a plant, or from a mixture of two or more of such essential oils to form a compound essential oil. The aforementioned fragrance is a fragrant substance that easily volatilizes and that is provided in a high concentration in the fragrant spray liquid. A common fragrant substance may include chemical elements, such as acid, alcohol, aldehyde, ester, ketone, terpenes, and phenol depending on the type and part of the plant from which the fragrant substance is extracted. In combination with the different kinds of the chemical elements, some of the fragrant substances have an effect of reducing inflammation and further provide a calming effect. Arose essential oil is an example of such a fragrant substance. Other fragrant substances have a stimulating effect, such as lemon, citronella, and other fragrant substances with a citronellal aroma. In this embodiment, the fragrance is selected depending on the intended application of the air filter. For example, if the air filter 2 is to be used inside a car, a fragrance having a stimulating effect is preferred. If the air filter 2 is to be used in an air-conditioning unit of a bedroom, a fragrance having a calming effect is preferred.

Referring to FIG. 3, the roll of screen 20 is advanced along a predetermined direction. Two spray devices 31, 32 are disposed spaced apart from each other along an advancing path of the screen 20. The spray device 31 contains the activated carbon-containing spray liquid, while the spray device 32 contains the fragrant spray liquid. A drying device 33 is disposed between the spray devices 31, 32. An additional drying device 34 is disposed rearwardly of the spray device 32. When the screen 20 advances continuously and passes the spray device 31, the activated carbon-containing spray liquid is sprayed on an outer surface 201 of the screen 20. When the screen 20 passes through the drying device 33, which has a temperature of about 160° C., the activated carbon liquid spray on the outer surface 201 of the screen 20 is heated and hardened, so that a coating layer of the activated carbon layer 22 is formed on the outer surface 201 of the screen 20. As the screen 20 with the activated carbon layer 22 advances to the spray device 32, the fragrant spray liquid is sprayed onto the activated carbon layer 22. When the screen 20 with the fragrant spray liquid passes through the drying device 34, which has a temperature of about 160° C., the fragrant spray liquid is heated and hardened to thereby form a coating layer of the fragrance material 23 on the outer surface 201 of the screen 20, and thereby complete formation of the air filter 2 of the present invention. The screen 20 is then cut to a suitable length as needed.

In use, when air passes through the air filter 2, large particles of dirt are filtered by the filter body 21, and an unpleasant odor in the air is filtered by the activated carbon layer 22. As the air passes through the fragrance material 23, scented air with a predetermined fragrance is produced and uniformly distributed inside the car or room. Hence, the air filter 2 of the present invention not only can filter impurities and unpleasant odor, but can also improve the scent/odor of the air after filtering the same, thereby enhancing the quality of the resulting filtered air.

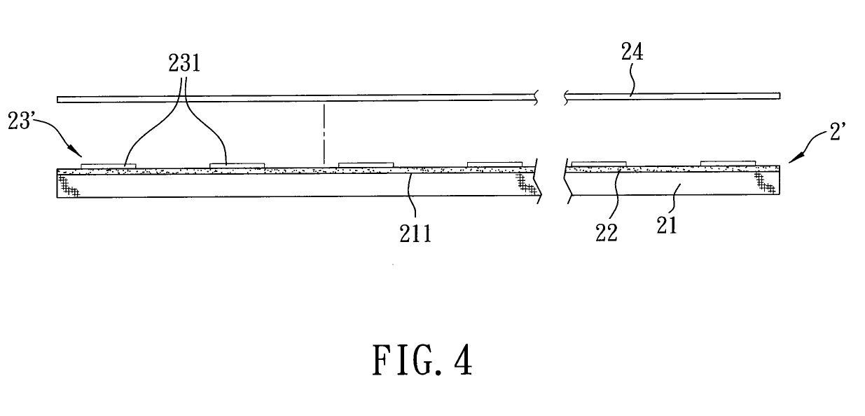

Referring to FIG. 4, an air filter 2′ according to the second preferred embodiment of the present invention is shown to be similar to the first preferred embodiment. However, in this embodiment, the fragrance material 23′ includes a plurality of spaced-apart fragrance-containing sheets 231 fixed to the activated carbon layer 22. To fix the fragrance-containing sheets 231 onto the activated carbon layer 22, the air filter 2′ further includes a covering layer 24 overlying the fragrance-containing sheets 231 and the activated carbon layer 22. The covering layer 24 is made of a material having minute holes that are densely formed, such as a non-woven fabric, a knitted fabric, a plain jersey fabric, etc. The covering layer 24 may be sewn or tied to the filter body 21 so as to position fixedly the fragrance-containing sheets 231 onto the activated carbon layer 22 and to sandwich the fragrance-containing sheets 231 between the filter body 21 and the covering layer 24. The effects of the present invention described in the first preferred embodiment may also be achieved using the second preferred embodiment.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

I claim:

1. An air filter adapted to be mounted on an air circulation path, comprising:
a filter body;
an activated carbon layer provided on an outer surface of said filter body; and
a fragrance material attached to said activated carbon layer.

2. The air filter of claim 1, wherein said fragrance material is sprayed onto said activated carbon layer.

3. The air filter of claim 2, wherein said activated carbon layer is a coating layer provided on said outer surface of said filter body through a spraying process followed by a drying process.

4. The air filter of claim 3, wherein said filter body is made of a non-woven fabric.

5. The air filter of claim 3, wherein said filter body is made of a knitted fabric.

6. The air filter of claim 3, wherein said filter body is made of a plain jersey fabric.

7. The air filter of claim 1, wherein said fragrance material includes a plurality of fragrance-containing sheets.

8. The air filter of claim 7, further comprising a covering layer overlying said fragrance-containing sheets and said activated carbon layer and positioning said fragrance-containing sheets on said activated carbon layer.

9. The air filter of claim 8, wherein each of said filter body and said covering layer is made of a non-woven fabric.

10. The air filter of claim 8, wherein each of said filter body and said covering layer is made of a knitted fabric.

11. The air filter of claim 8, wherein each of said filter body and said covering layer is made of a plain jersey fabric.
